(19) United States
(12) Patent Application Publication
(10) Pub. No.: US 2019/0368152 A1
(43) Pub. Date: Dec. 5, 2019

(54) METHOD FOR MAKING MODULAR RETAINING WALL BLOCK WITH LEVER EXTENSION USING CMU BLOCK MACHINE

(71) Applicant: Earth Wall Products, LLC, Marietta, GA (US)

(72) Inventor: Thomas L. Rainey, Marietta, GA (US)

(21) Appl. No.: 16/382,790

(22) Filed: Apr. 12, 2019

Related U.S. Application Data
(63) Continuation-in-part of application No. 62/922,213, filed on May 30, 2018.

(51) Int. Cl. E02D 29/02; B28B 7/18; E04C 1/39

(52) U.S. Cl. CPC E02D 29/025; E04C 1/395; B28B 7/183

(57) ABSTRACT

Disclosed are embodiments of a new modular retaining wall block and method for manufacturing the block using a commercial masonry unit (CMU) block machine. The block includes a lever extension, preferably extending outwardly from a rear side of the block that anchors and inhibits forward tipping of the block when placed in a wall with backfill soil and that enables the block to be made substantially lighter than conventional blocks. Although not optimal for anchoring, the top surface angle of the lever extension is set at approximately 45 degrees to enable the concrete to sufficiently enter a part of the interior cavity of the mold used in the CMU block machine that forms the lever extension and to enable the lever extension to remain sufficiently intact in the partially cured condition during and after placement on a pallet.

### CLAIM OF PRIORITY

This application is a continuation-in-part (CIP) of and claims priority to and the benefit of application Ser. No. 15/992,625, filed May 30, 2018, which is incorporated by reference herein in its entirety.

### TECHNICAL FIELD

The present disclosure is related to the segmental or modular block retaining walls used in grade separations of earth fills and embankments, and more particularly, to a new design for a modular retaining wall block and method for making the same using a conventional commercial masonry unit (CMU) block machine.

### BACKGROUND OF THE INVENTION

Modular earth retaining walls are commonly used for architecture and site development applications. Such earth retaining walls have a distinct need for constructability and the ability to be manually stacked with the modular blocks having a reasonable weight. The current masonry concrete modular blocks available on the market are relatively heavy, each on the order of about 75 pounds and each is typically about 8 inches tall by about 18 inches in width by about 12 inches depth.

With most of the modular blocks being produced currently in the 75 pound range, this hinders the ability to find laborers that will stack these heavy blocks continuously over the course of a day without injury or excessive fatigue. A more reasonable block weight to be installed with manual labor would be on the order of about 50 pounds. There have been numerous attempts by block manufacturers to produce a reduced weight modular block, but issues arise with regard to stability and/or performance of the lighter weight or smaller units. Therefore, there is a need in the industry with respect to modular blocks to be both smaller and/or lighter in weight, but perform structurally and to hold alignment when constructed as the current heavier weight and larger size modular blocks.

### SUMMARY OF THE INVENTION

The present disclosure provides embodiments of new modular retaining wall block and method for manufacturing the blocks.

The block is lighter than conventional designs, but performs to the required standards of a heavier weight block or larger modular block. The new block includes an additional lever, or protruding portion, of the modular block to allow the backfill placed behind the modular block to add the weight of the backfill soils to the rear of the modular block, resulting in downward pressure on the block to increase stability. The additional lever is cast monolithically in the manufacturing process of the modular block and hence does not require any added device or equipment other than the modular block to provide the additional stability.

When modular blocks are used to construct earth retaining walls, a plurality of modular blocks interact together to form the entire retaining wall. One of the issues with current modular blocks is the limitation to only be able to stack two to three modular blocks vertically until they are backfilled with soil behind the modular blocks without the modular blocks moving out of alignment or tilting forward. Too much pressure from the rear of the modular block will cause the retaining wall alignment being constructed with modular blocks to rotate or slide forward and out of the prescribed or intended alignment. Pressure at the rear of the modular block is caused by the soil backfill and soil compaction to consolidate the soil backfill. The current typical industry size of modular blocks is 12 inches deep. Several modular block manufacturers have attempted to use lighter and smaller modular blocks, but have been unable to provide the stability required and constructability needed to meet industry and construction standards. The current invention, which includes a rear extension of the modular block geometry takes advantage of the soil backfill weight to create downward pressure on the back of the modular block. With the additional downward pressure on the back of the modular block created by the unique protruding geometry, a smaller and more lightweight masonry concrete modular block can be used. The additional stability assistance provided by the rear extension, or lever, has been shown through testing to provide equivalent stability as larger and/or heavier modular blocks currently on the market.

In essence, the new embodiments of the present disclosure allow for lighter and smaller modular blocks to provide the stability required for constructability and performance as larger and heavier modular blocks.

So, one embodiment, among others, is a modular retaining wall block having a plurality of sides including a front, rear, right, left, top, and bottom sides. The block further comprises a lever extension that has a body that extends outwardly from a side of the block, preferably from a lower region of the rear side. Moreover, the lever extension has a top surface extending at an outward and downward angle from an upper point to a lower point on the side. When a retaining wall is created with blocks of this nature, soil exerts downward force (weight) upon, among other thing, the lever extension, to thereby inhibit forward tipping movement of the blocks.

Another embodiment, among others, is a retaining wall constructed from a plurality of modular retaining wall blocks. The retaining wall has at least first and second rows, each having a plurality of the modular retaining wall blocks. The second row of blocks is stacked upon and staggered over the first row of blocks. Each of the blocks has a plurality of sides including a front, rear, right, left, top, and bottom sides. Each of the blocks has a lever extension that has a body that extends outwardly from a lower region of the rear side. The lever extension has a top surface extending at a downward angle from an upper part to a lower part and outwardly from the rear side. Furthermore, backfill soil resides along the rear sides of the blocks of the first and second rows. The backfill soil exerts downward force (weight) upon the top surfaces of the lever extensions associated with the blocks of the first and second rows to inhibit forward tipping movement of the blocks.

Another embodiment, among others, is a retaining wall constructed from a plurality of modular retaining wall blocks. The retaining wall has first and second rows, each having a plurality of the modular retaining wall blocks. The second row of blocks is stacked upon and staggered over the first row of blocks. Each of the blocks has a plurality of external sides. Each of the blocks may or may not have a core defined by a plurality of internal sides. Each of the blocks has a lever extension that has a body that extends outwardly from at least one of the external and internal sides. The body of the lever extension has an angled top surface that extends from a top point outwardly and downwardly to a lower point. Furthermore, backfill soil resides along the rear sides of the blocks of the first and second rows. The backfill soil exerts downward force (weight) upon the top surfaces of the lever extensions associated with the blocks of the first and second rows to inhibit forward tipping movement of the blocks.

Another embodiment, among others, is a method for producing concrete modular retaining wall blocks using a commercial masonry unit (CMU) block machine. Each of the blocks has a plurality of sides including a front, rear, right, left, top, and bottom sides and a lever extension extending from the rear side. The method can be summarized as follows: (a) providing the CMU block machine, the CMU block machine having a mold, the mold having an opening for receiving concrete into an interior cavity that defines an exterior of the block including the lever extension, the lever extension having a body that extends outwardly from a lower region of a rear side of the block, the lever extension having a top surface extending at an outward and downward angle of approximately 45 degrees from an upper point to a lower point on the rear side, the lever extension having a bottom surface that extends along and is coplanar with a bottom surface of the block; (b) moving the concrete downwardly into the opening associated with the mold; (c) compacting the concrete in the mold; (d) separating the mold and the concrete to expose the block in an upright position in a partially cured condition and sitting on a pallet; and (d) permitting the block to fully cure after the separating. The top surface angle of the lever extension is set at approximately 45 degrees to enable the concrete to sufficiently enter a part of the interior cavity that forms the lever extension during the pouring and compacting and furthermore to enable the lever extension to remain sufficiently intact in the partially cured condition during and after the separating.

Another embodiment, among others, is a block produced with the method described in the previous paragraph. Such block has the lever extension with the top surface angle of about 45 degrees. Although this angle is not optimal for the anchoring effect, it is sufficient to some extent and enables the block to be made lighter as well as be manufactured with the CMU block machine (and without having to produce such a block with a wet casting process, which is much slower).

Other embodiments, systems, methods, apparatus, features, and advantages of the present invention will be or become apparent to one with skill in the art upon examination of the following drawings and detailed description.

### BRIEF DESCRIPTION OF THE DRAWINGS

Many aspects of the disclosure can be better understood with reference to the following drawings. The components in the drawings are not necessarily to scale, but emphasis instead being placed upon clearly illustrating the principles of the present disclosure. Moreover, in the drawings, like reference numerals designate corresponding parts throughout the several views.

FIG. 1 is a front isometric view of an embodiment of a new modular retaining wall block in accordance with the present disclosure.

FIG. 2 is a back isometric view of the modular retaining wall block of FIG. 1.

FIG. 3 is a top view of the modular retaining wall block of FIG. 1.

FIG. 4 is a side view of the lever extension of the modular retaining wall block of FIG. 1.

FIG. 5 is a side view of the modular retaining wall block of FIG. 1.

FIG. 6 is a rear view of the modular retaining wall block of FIG. 1.

FIG. 7 is a side view of a plurality of the modular retaining wall blocks of FIG. 1 in a stacked configuration showing the rear levers in place.

FIG. 8 is a side view of a plurality of the modular retaining wall blocks of FIG. 1 in a stacked configuration showing the ability to capture the backfill weight when trying to overturn the modular retaining wall blocks.

FIG. 9 is a side view of typical modular retaining wall blocks (prior art) in a stacked configuration, lacking the rear levers.

FIG. 10 is a side view of the stacked modular retaining wall blocks of FIG. 8 with the rear levers when overturning due to earth pressure from rear.

FIG. 11 is a side view of the stacked modular retaining wall blocks of FIG. 9 without levers when overturning with no added benefit of backfill weight helping to stabilize or prevent overturning.

FIG. 12 is a side view of another possible geometry for the rear side of the new modular retaining wall block of the present disclosure to create downward pressure from soil backfill to the rear portion of the modular block.

FIG. 13 is an isometric view of another possible geometry for the lever extension of the new modular retaining wall block of the present disclosure, the lever extension being cast on the side as well as the rear side of the block.

FIG. 14 is a side view of another possible geometry for the lever extension of the new modular retaining wall block of the present disclosure, the lever extension being cast on the side as well as the back of the block.

FIG. 15 is a side view of another possible geometry for the lever extension of the new modular retaining wall block of the present disclosure, the lever extension being located higher up on the rear side of the block.

FIG. 16 is a top view of another possible geometry for lever extensions of the new modular retaining wall block of the present disclosure, the lever extensions situated inside a center core on an internal side as well as on the rear side of the block.

FIG. 17 is a side view of the block of FIG. 16.

FIG. 18 is a top view of another possible geometry for lever extensions of the new modular retaining wall block of the present disclosure, the lever extensions being situated on sides, inside a center core on an interval side, and on the rear side.

FIG. 19 is a top view of another possible geometry for a rear lever extension of the new modular retaining wall block of the present disclosure that has side dimensions greater than front and rear sides.

FIG. 20 is a perspective view of a prior art example of a commercial masonry unit (CMU) block machine for making concrete blocks.

FIG. 21 is a flowchart showing a method of the present disclosure for making concrete blocks that have a lever extension extending outwardly and horizontally from the rear side.

### DETAILED DESCRIPTION OF THE INVENTION

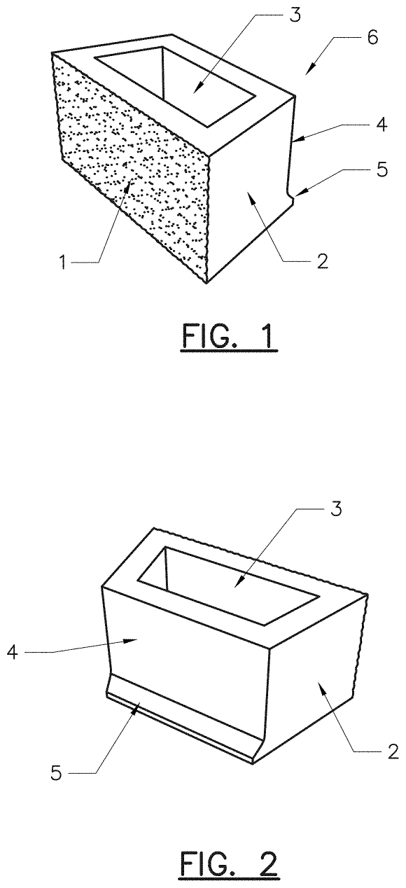

Referring now in detail to the drawings, in which like numerals indicate corresponding parts throughout the several views, FIGS. 1 through 6 illustrate a modular, or segmental, retaining wall block with the common features of a face style 1 with side 2 and rear face 4. Most, but not all, will have a center core 3 as shown to lighten the block. The current invention involves adding a rear lever extension 5, or protrusion, to the rear vertical face of the modular retaining wall block. The block is made of masonry concrete and can vary in weight between 50 and 115 pounds each. The individual modular blocks are typically dry stacked (i.e., no mortar or grout is used) and often include one or more features adapted to properly locate adjacent blocks and/or courses with respect to one another and provide resistance to sheer forces from course to course. Modular block retaining walls are subjected to high loads exerted by the soil behind the walls as well as, among other things, character of the soil, the presence of water, temperature, and shrinkage effects as well as seismic loads.

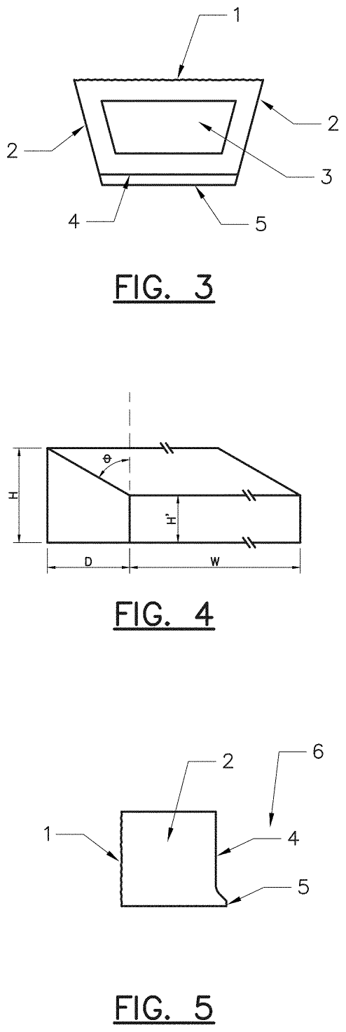

To further illustrate the new block, FIG. 2 is a rear isometric view showing the side 2, rear 4, center core 3, and rear lever extension 5. When observing the block with the improved rear lever extension from the top, see FIG. 3 which shows the architectural face 1, sides 2, center core 3, rear face 4, and rear lever extension 5.

The front face, or front surface, is the visible part of the completed retaining wall. The front face is typically a split masonry face, or rough in texture, to create a pleasing stone-like aesthetic look.

A side view of the lever extension 5 is illustrated in FIG. 4. Although not limited to this geometry, the preferred embodiment of the lever extension 5 has the following dimensions: a total height H of 1¾ inches, a front face height H′ of ¾ inches, a depth D of 1 inch, a width W of 18 inches, and a top angled surface that extends from a top point on the rear side in a direction outwardly and downwardly at an approximate angle theta of 45 degrees.

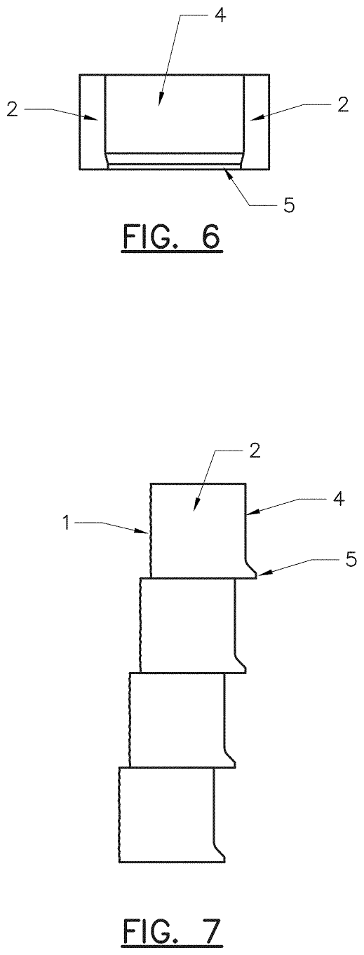

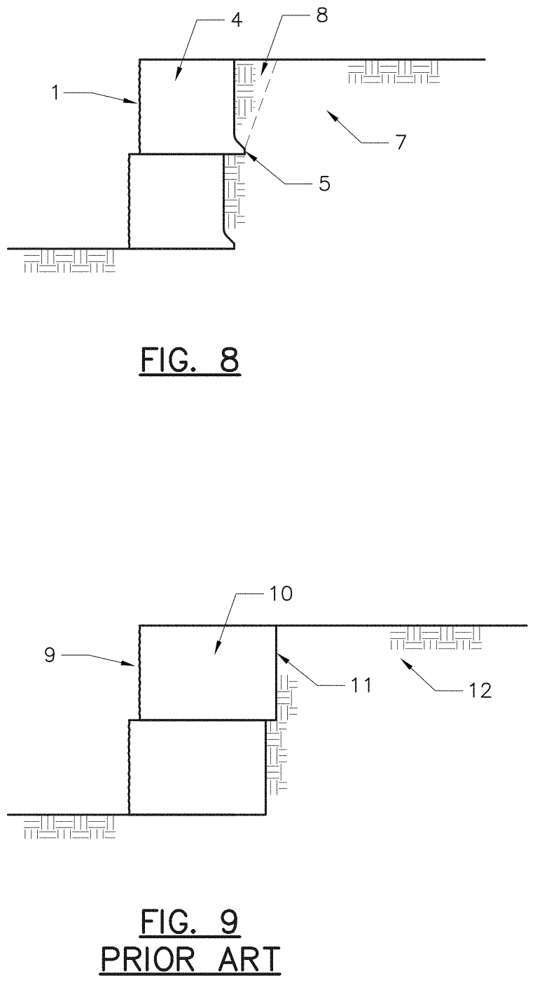

FIG. 5 shows a side view of the modular block of FIGS. 1 through 4 to further illustrate the protruding lever extension that protrudes rearwardly from the vertical rear face of the block to create interaction with the rear backfill soils. FIG. 6 is a rear view of the block with the lever extension 5 with sides 2 and rear face 4 shown. To create a retaining wall with the blocks, the blocks are stacked vertically, which is illustrated in FIG. 7. When the blocks are backfilled behind with soil 7, the blocks will tend to remain in place with the assistance of soil resting above the rear lever extension 5 shown in FIG. 8. This wedge of backfill soil effectively creates a downward pressure on the rear of the modular block which assists with preventing the modular block from tending to overturn due to the earth pressure present on the backfill side of the modular block, which is opposite the front face 1.

Typical modular blocks (prior art) have straight sides or near vertical with no extensions or protrusions as illustrated in FIG. 9. This geometry has been commonplace since the beginning of the common modular block retaining wall industry beginning in the 1980s. As illustrated in FIG. 9, the rear 11 and side faces 10 of such blocks are near vertical. The backfill soils behind a conventional modular block retaining wall 12 is compacted behind the modular block.

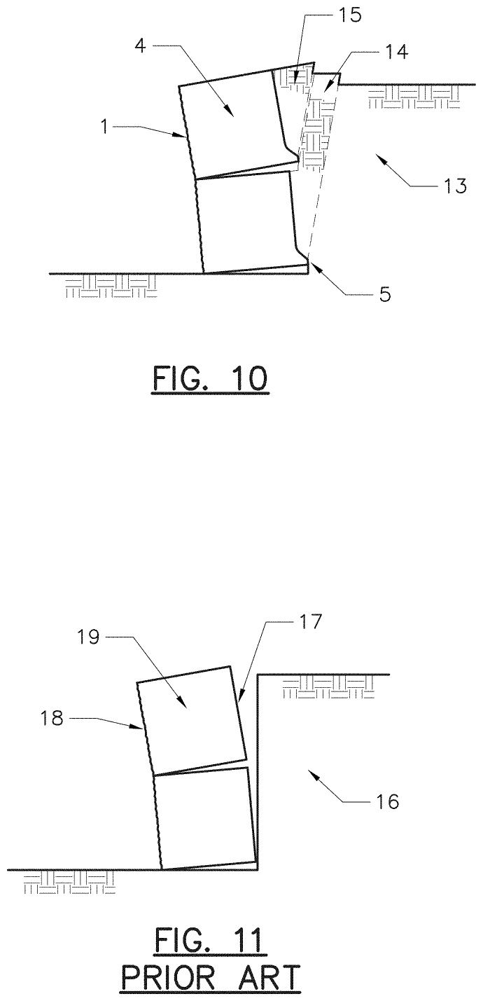

In order to illustrate the performance of the new modular retaining wall block of the present disclosure, FIG. 10 shows how and where active movement of the block will engage the protruding lever extension 5 to begin lifting up the soil backfill within the zone of influence 14, 15 (or wedge) which requires additional force. Effectively the rear lever captures soil backfill weight as an assistant or additional stabilization to keep the modular block in place and to impede overturning movement. In contrast to the current modular block geometry (prior art) as shown in FIG. 11, the backfill 16 does not have direct interaction with the rear surface 17 or side 19. The overturning of the conventional modular block is then only stabilized by the weight of the modular block itself with no assistance from the backfill soil 16.

The lever extension 5 of the previously described embodiment as well as other embodiments to be described later in this section exhibit an angled top having a surface that extends outwardly and downwardly from an upper part to a lower part. Although not necessary to accomplish the anchoring effect, the angled top is preferred because of the casting process and machine that is preferably utilized to make the new modular retaining wall blocks of the present disclosure. Also, because of the casting process and machine, there is a radius where the upper part meets the vertical part of the rear wall of the block. Furthermore, in the preferred embodiments, the angle of the top of the lever extension 5 is about 45 degrees from horizontal.

More specifically, to enable easy mass production, a commercial masonry unit (CMU) fabrication unit with an appropriate mold can be and is typically used to make the segmented blocks, like the new modular retaining wall blocks of the present disclosure. Each mold usually about 24 inches wide and makes two blocks with their faces opposing each other. Concrete is poured into the mold from the top and pressed, and then the mold is removed from the top to expose the blocks. Usually, the blocks are about 8 inches in height, about 12 inches in depth, and about 18 inches in width.

In order to create a lever extension as an integral part of a block in the 24 inch mold, which makes two blocks at a time, the preferred block size is about 8 inches in height, about 9 inches in depth, and about 18 inches in width, and the preferred lever extension has a front face that is about ¾ inches in height and that extends outwardly from the block rear wall by about 1 inch. The height of the front face ensures the integrity of the front bottom edge. Moreover, the 1 inch lever extension ensures the desired anchoring effect based upon the 9 inch block depth. A larger outward extension, for example, 2 inches, would achieve a better anchoring effect, but this would mean that the blocks would need to be manufactured with a smaller depth due to the 24 inch width of the mold, which makes two at a time. Furthermore, it is believed, based upon testing and the inventor's experience, that the minimum outward dimension for the lever extension is about ¼ inch in order to achieve the desired anchoring effect with the aforementioned block sizes.

The angled top of the lever extension is desired so that the concrete fully flows into the mold cavity that forms the lever extension and also enables the mold to be more easily removed from the top of the CMU fabrication unit. It is possible to achieve the anchoring effect even if the lever extension 5 had a top with a surface that is horizontally flat (i.e., top surface at a right angle to rear side) or a top with a surface that is even angled upwardly (i.e., from a lower part to an upper part) to some extent, if such a lever extension 5 can be fabricated.

The tops of the lever extension 5 are preferably planar for ease in fabrication. However, the tops do not necessarily need to be planar and may have a non-planar topography.

Further note that in some alternative embodiments of a block, the longitudinal body of the lever extension 5 of FIGS. 1 through 6 extends outwardly from the rear side of the block but only partially along a width associated with the rear side.

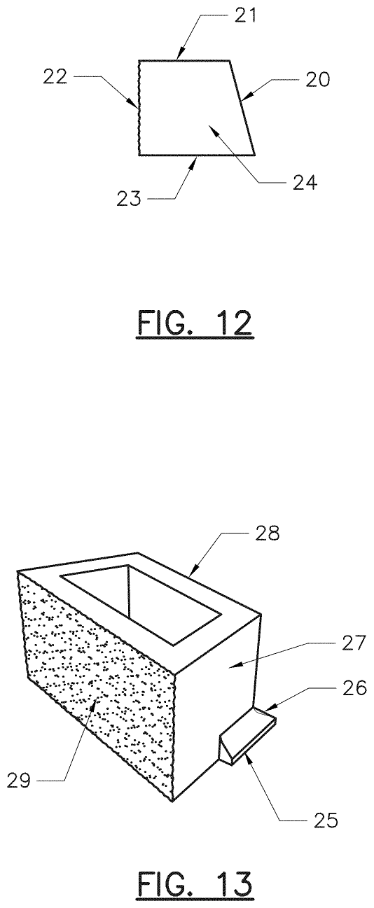

While the lever extension 5 of the new modular retaining wall block as shown in the earlier FIGS. 1 through 6 is located at the rear of the block, other geometries are possible to create a similar stabilizing effect by getting the soil backfill to add additional downward resistance or load to the modular block. For example, a wedge could be imparted on the rear surface 20 as shown in FIG. 12 (i.e., the rear surface is sufficiently angled forwardly and downwardly from vertical), so the block 24 with a top 21, bottom surface 23, and front face 22 is assisted by downward pressure from the backfilled soils to resist overturning. This concept and geometry can also be applied to an internal wall associated with a core.

Still another possible embodiment is shown in FIGS. 13 and 14. As shown in FIGS. 13 and 14, the block has a lever extension 25 extending out from the vertical face of each side 27 as well as the rear 28. In this embodiment, the lever extension 25 wraps around the block from the right side to the rear side to the left side. The lever extension can in combination be used individually at rear 26 and sides 25.

In alternative embodiments for a block, a lever extension 25 can be placed only at one or more sides of the block to inhibit forward tipping movement of the block.

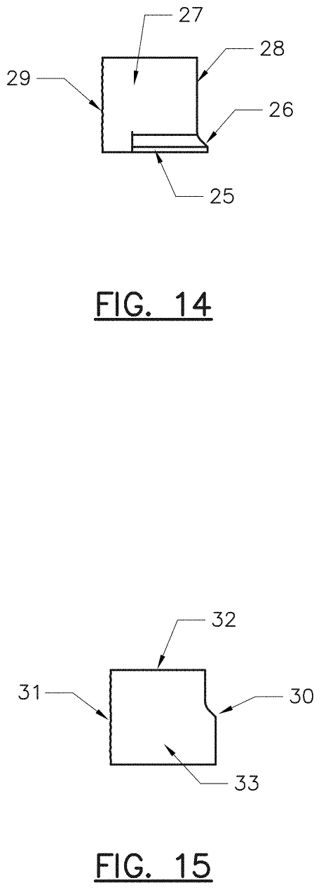

FIG. 15 is a side view of another possible embodiment for the lever extension of the new modular retaining wall block of the present disclosure. In this embodiment, the lever extension is made from the bottom part of the rear side of the block so that the angled upper part of the lever extension is located higher up on the rear side of the block.

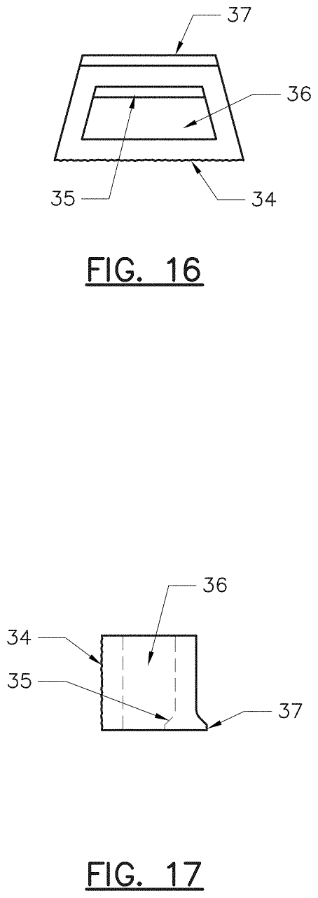

FIGS. 16 and 17 are a top view and a side view, respectively, of another possible embodiment for lever extensions of the new modular retaining wall block of the present disclosure. One lever extension 35 is situated inside a center core 36 on an internal side, and another lever extension 37 is situated on the rear side of the block.

In alternative embodiments for a block, a lever extension may be placed and extend from one or more internal sides that define one or more cores in the block in order to inhibit forward tipping movement when the block is installed in a retaining wall.

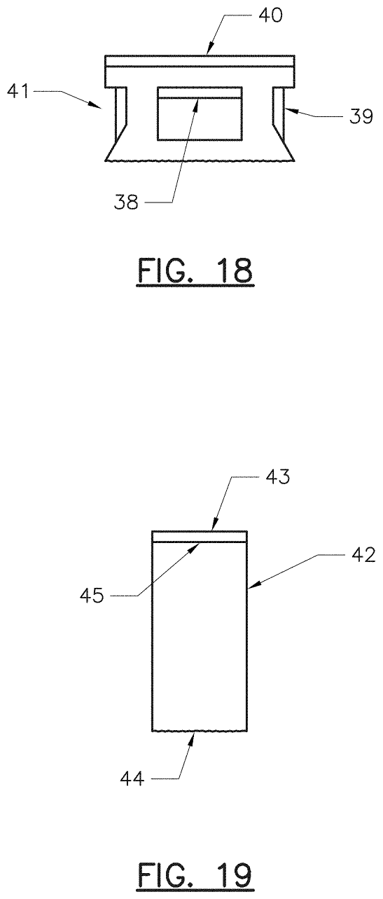

Note that the block shape may vary. FIG. 18 is a top view of another possible embodiment for lever extensions of the new modular retaining wall block of the present disclosure. There are lever extensions 39 and 41 situated on sides, lever a lever extension 38 inside a center core on an interval side, and a lever extension 40 on the rear side.

Some embodiments of the block may have a narrower shape. More specifically, FIG. 19 shows a top view of another possible geometry for a rear lever extension 43 of the new modular retaining wall block of the present disclosure that has sides 42 with dimensions that are greater than front and rear sides 44, 45.

Test Information on Modular Retaining Wall Blocks with Lever Extension

In order to verify the performance of the lever extension on the rear of a modular retaining wall block, a series of overturning tests were performed. The first overturning test was for a typical 12-inch deep, modular retaining wall block, which developed an overturning force requirement when backfilled with stone of about 71.0 pounds. A typical 9-inch deep modular retaining wall block was used in an identical situation as before with stone backfill, which only required about 35.4 pounds to overturn. The last retaining wall modular block to be overturned in gravel was another 9-inch deep modular retaining wall, but with the lever extension of FIGS. 1 through 6 included. The resulting overturning force measured was about 70.5 pounds. These results are summarized in the table below and verify the more shallow, 9-inch deep, modular retaining wall block with lever extension provides the same overturning resistance as the typical 12-inch deep, modular retaining wall block without the lever extension.

TABLE A
Overturning Force Test Results

| | |
|---|---|
| 12-inch Deep Retaining Wall Modular | 71.0 pounds |
| Block | |
| 9-inch Deep Retaining Wall Modular | 35.4 pounds |
| Block | |
| 9-inch Deep Retaining Wall Modular | 70.5 pounds |
| Block with Lever Extension | |

Method for Producing Blocks with Lever Extension

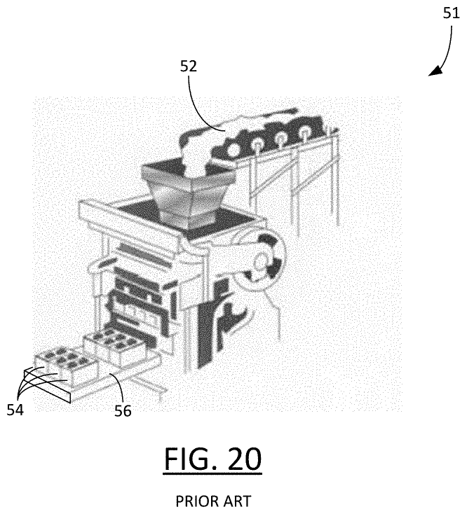

First, concrete is mixed for making the blocks. After mixing the concrete, the concrete is conveyed to a hopper on top of a CMU block machine at a measured flow rate. An example of a CMU block machine is shown in FIG. 20 and denoted by reference numeral 51. In the CMU block machine 51, the concrete is poured or otherwise forced downwardly 52 into one or more molds. Usually, each of the molds consists of an outer mold box containing several mold liners. The liners determine the outer shape of the block and the inner shape of the block cavities, if any.

When the molds are full, the concrete is compacted, or pressed, by the weight of the upper mold head coming down on the mold cavities. This compaction may be supplemented by air or hydraulic pressure cylinders acting on the mold head. Most CMU block machines 51 also use a short burst of mechanical vibration to further aid compaction.

The compacted blocks 54 are pushed down and out of the molds onto a flat steel pallet 56. The pallet 56 and blocks 54 are pushed out of the machine 51 and onto a conveyor. In some operations, the blocks 54 then pass under a rotating brush which removes loose material from the top of the blocks 54.

The pallets 56 of blocks 54 are conveyed to an automated stacker or loader, which places them in a curing rack. Each rack holds several hundred blocks. When a rack is full, it is rolled onto a set of rails and moved into a curing kiln. The kiln is an enclosed room with the capacity to hold several racks of blocks at a time.

A typical CMU dry cast masonry block 54 produced on a CMU block machine 51 has straight vertical sides and therefore allows efficient and fast production of the blocks. Due to the simple straight vertical sides, the cycle time for production is typically one every 3 seconds. If horizontal protrusions, or extensions, from the block sides are needed, production has typically gone to wet cast mold production, where a mold is assembled, concrete is poured into it, and then the mold is disassembled to remove the block. An example of blocks that are produced in this manner are the commercially available Gravix and Forix blocks, which the inventor herein previously developed and patented under U.S. Pat. No. 8,684,635 B2. The wet cast mold and process is more labor intensive and time-consuming, producing typically one cast unit per day. Block production on a CMU machine 51, such as that in FIG. 20, can produce upwards of 1,000 units per day.

The present disclosure provides a method to produce a horizontal, rearwardly extending, lever extension from the rear side of a block using a conventional CMU machine 51 without having to go through a wet cast production cycle. The challenge is the filling of the lever extension in the CMU block machine 51 while achieving the lever extension and cyclical production without interrupting the block cycle. Typically, a horizontal extension is not possible on a block made with the CMU block machine; however, the inventor has discovered an angle and extension geometry that can be produced and repeated. Even though this angle is not optimal for its intended purpose, the inventor determined through experimentation and various trials that a 45-degree angle (approximately) is needed to make the filling and compaction possible. Several mold configurations were attempted to find the actual angle where this works and is repeatable to keep the machine from being stopped for cleaning or for bad product being produced. Tests have shown the current protrusion geometry to increase the overturning and therefore production efficiency to warrant the extension to be included for better segmental block performance.

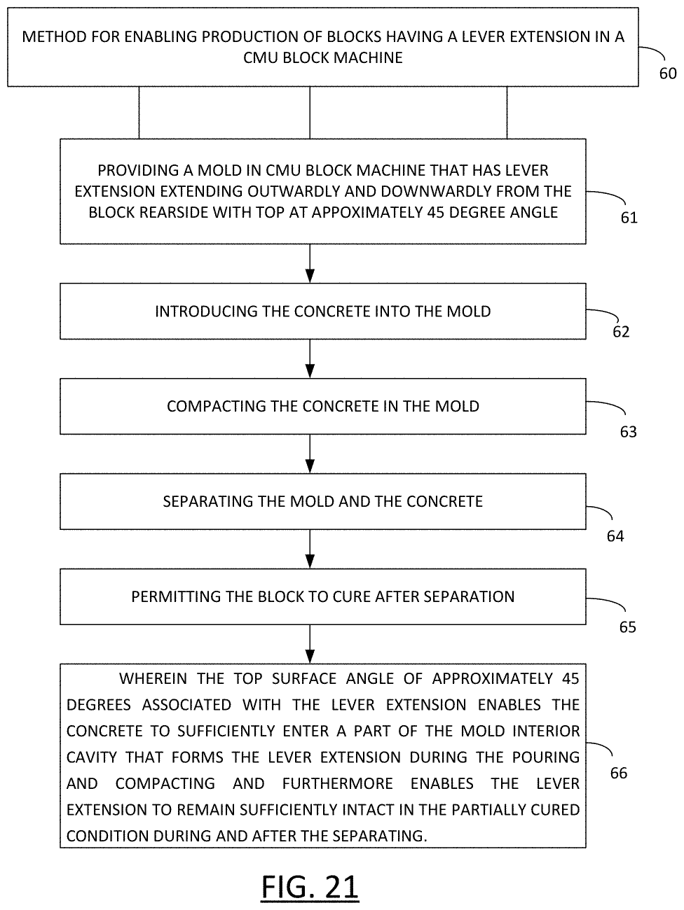

FIG. 21 summarizes the method, which is denoted by reference numeral 60. First, as indicated step 61, a mold is provided in the CMU block machine 51. The mold situated upon and separable from a support surface, such as a metal pallet. The mold has an opening(s), or aperture(s), for receiving concrete into an interior cavity that defines an exterior of the block including the lever extension. The lever extension has a body that extends outwardly from a lower region of a rear side of the block. The lever extension has a top surface extending at an outward and downward angle of approximately 45 degrees from an upper point to a lower point on the rear side. In some embodiments, among others, the lever extension has a bottom surface that extends along and is coplanar with a bottom surface of the block.

As indicated at step 62, the concrete is introduced, e.g., poured, forced downwardly, etc., into the opening associated with the mold;

Next, the concreted is compacted, or pressed, in the mold, and perhaps vibrated (optional), as indicated at step 63.

At step 64, the mold and the concrete are then separated to expose the block in an upright position in a partially cured condition sitting on the pallet 56.

As indicated at step 65, the block is permitted to fully cure after the separating step.

As further indicated at reference numeral 66, the top surface angle of approximately 45 degrees associated with the lever extension enables the concrete that is introduced in a vertical direction to sufficiently enter, in a horizontal direction, a part of the interior cavity of the mold that forms the lever extension and furthermore enables the lever extension to remain sufficiently intact in the partially cured condition during and after the separating.

In the preferred embodiment, two blocks of FIG. 1 are manufactured during each cycle of the CMU block machine 51 and are placed in an upright position with front faces facing each other on a single metal pallet. Each block exhibits the following approximate measurements: 8 inches in height, 9 inches in depth, and 18 inches in width. Moreover, the lever extension on each block exhibits the following approximate measurements: 1¾ inches in height, 1 inch in depth, 18 inches in width.

### Variations and Modifications

It should be emphasized that the above described embodiments of the present disclosure or new invention are merely possible examples of implementations merely set forth for a clear understanding of the principles of the disclosure. Many variations and modifications may be made to the above described embodiments of the disclosure without departing substantially from the principles of the disclosure. All such modifications are intended to be included therein to the scope of this disclosure.

Therefore, having thus described the invention, at least the following is claimed:

1. A method for producing concrete modular retaining wall blocks using a commercial masonry unit (CMU) block machine, each of the blocks having a plurality of sides including a front, rear, right, left, top, and bottom sides and a lever extension extending from the rear side, the method comprising:
providing the CMU block machine, the CMU block machine having a mold, the mold having an opening for receiving concrete into an interior cavity that defines an exterior of the block including the lever extension, the lever extension having a body that extends outwardly from a lower region of a rear side of the block, the lever extension having a top surface extending at an outward and downward angle of approximately 45 degrees from an upper point to a lower point on the rear side, the lever extension having a bottom surface that extends along and is coplanar with a bottom surface of the block;
introducing the concrete downwardly into the opening associated with the mold;
compacting the concrete in the mold;
separating the mold and the concrete to expose the block in an upright position in a partially cured condition and sitting on a pallet; and
permitting the block to fully cure after the separating;
wherein the top surface angle of approximately 45 degrees associated with the lever extension enables the concrete to sufficiently enter a part of the interior cavity that forms the lever extension during the pouring and compacting and furthermore enables the lever extension to remain sufficiently intact in the partially cured condition during and after the separating.

2. The method of claim 1, wherein the block exhibits the following approximate measurements: 8 inches in height, 9 inches in depth, and 18 inches in width; and wherein the lever extension exhibits the following approximate measurements: 1¾ inches in height, 1 inch in depth, 18 inches in width.

3. The method of claim 1, wherein the body of the lever extension also extends outwardly from a lower region of the right side, the left side, or both.

4. The method of claim 1, wherein the body of the lever extension extends outwardly along the entire width of the rear side.

5. The method of claim 1, wherein the body of the lever extension extends outwardly from the rear side but only partially along a width associated with the rear side.

6. The method of claim 1, wherein the block further comprises:
internal walls defining a core; and
at least one second extension that has a body that extends outwardly from a lower region of at least one of the internal walls, the at least one second extension having a top surface extending at a downward angle from an upper part to a lower part and outwardly from the one internal wall.

7. The block produced by the method of claim 1.

8. The method of claim 1, wherein the mold is designed to concurrently produce two of the blocks and further comprising the blocks on the pallet.

9. A method for producing concrete modular retaining wall blocks using a commercial masonry unit (CMU) block machine, each of the blocks having a plurality of sides including a front, rear, right, left, top, and bottom sides and a lever extension extending from the rear side, the method comprising:
providing the CMU block machine, the CMU block machine having a mold situated upon and separable from a support surface, the mold having an opening for receiving concrete into an interior cavity that defines an exterior of the block including the lever extension, the lever extension having a body that extends outwardly from a lower region of a rear side of the block, the lever extension having a top surface extending at an outward and downward angle of approximately 45 degrees from an upper point to a lower point on the rear side, the lever extension having a bottom surface that extends along and is coplanar with a bottom surface of the block;
introducing the concrete downwardly into the mold;
compacting the concrete in the mold; and
separating the mold and the concrete to expose the block in an upright position in a partially cured condition.

10. The method of claim 9, further comprising placing the block on a pallet in the upright position.

11. The method of claim 9, further comprising transporting the block to a kiln and curing the block so that the block exhibits a fully cured condition.

12. The method of claim 9, wherein the block exhibits the following approximate measurements: 8 inches in height, 9 inches in depth, and 18 inches in width; and wherein the lever extension exhibits the following approximate measurements: 1¾ inches in height, 1 inch in depth, 18 inches in width.

13. The method of claim 9, wherein the body of the lever extension also extends outwardly from a lower region of the right side, the left side, or both.

14. The method of claim 9, wherein the body of the lever extension extends outwardly along the entire width of the rear side.

15. The method of claim 9, wherein the body of the lever extension extends outwardly from the rear side but only partially along a width associated with the rear side.

16. The method of claim 9, wherein the block further comprises:
internal walls defining a core; and
at least one second extension that has a body that extends outwardly from a lower region of at least one of the internal walls, the at least one second extension having a top surface extending at a downward angle from an upper part to a lower part and outwardly from the one internal wall.

17. The block produced by the method of claim 9.

18. The method of claim 9, wherein the mold is designed to concurrently produce two of the blocks and further comprising the blocks on the pallet.

19. The method of claim 18, further comprising repeating the introducing, compacting, and separating steps in order to produce more blocks.

20. A method for producing concrete modular retaining wall blocks using a commercial masonry unit (CMU) block machine, each of the blocks having a plurality of sides including a front, rear, right, left, top, and bottom sides and a lever extension extending from the rear side, the method comprising:
providing the CMU block machine, the CMU block machine having a mold means for producing a block having a plurality of sides including a front, rear, right, left, top, and bottom sides and a lever extension extending from the rear side, the lever extension having a top surface extending at an outward and downward angle of approximately 45 degrees from an upper point to a lower point on the rear side;
filling the mold means with concrete; and
separating the mold and the concrete to expose the block in a partially cured condition.
